(19) United States
(12) Patent Application Publication
(10) Pub. No.: US 2009/0276791 A1
(43) Pub. Date: Nov. 5, 2009

(54) TECHNIQUES FOR FACILITATING SERVER CALLBACKS

(75) Inventor: Henricus Johannes Maria Meijer, Mercer Island, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/113,211

(22) Filed: May 1, 2008

(51) Int. Cl. G06F 9/46

(52) U.S. Cl. 719/318

(57) ABSTRACT

Various technologies and techniques are disclosed for facilitating server callbacks. A request is received from a client computer to monitor for one or more events for the client computer. The server computer monitors for the one or more events and detects one or more occurrences of the events. Information regarding the one or more occurrences of the events is added to an event queue. On a later communication with the client computer, the event queue is sent as part of a response so the occurrences of the events can be handled on the client computer by one or more event handlers on the client computer. Techniques are also described for enabling server callbacks in execution context splitting scenarios where a region of code has been split across different execution contexts.

### BACKGROUND

With the continued evolution of the Internet, an increasing number of web sites are being created every day. The HyperText Transfer Protocol (HTTP) protocol has become the de facto standard for communication between the client web browser and the server that returns the web pages. The HTTP protocol only allows clients to initiate calls to the server, but does not provide a way for the server to initiate a call to the client.

### SUMMARY

Various technologies and techniques are disclosed for facilitating server callbacks. A request is received from a client computer to monitor for one or more events for the client computer. The server computer monitors for the one or more events and detects one or more occurrences of the events. Information regarding the one or more occurrences of the events is added to an event queue. On a later communication with the client computer, the event queue is sent as part of a response so the occurrences of the events can be handled on the client computer by one or more event handlers on the client computer.

In one implementation, techniques are also described for enabling server callbacks in execution context splitting scenarios where a region of code has been split across different execution contexts. A client proxy is generated with an event handler. The event handler is operable to handle a certain event on a client computer. A server proxy is generated with an event handler proxy. The event handler proxy is operable to detect one or more occurrences of the certain event on a server computer and put information regarding the one or more occurrences into an event queue for later handling by the event handler of the client proxy.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a server callback system of one implementation.

FIG. 2 is a process flow diagram for one implementation illustrating the stages involved in monitoring for events on a server computer and putting raised events into an event queue for handling on a client computer.

FIG. 3 is a process flow diagram for one implementation illustrating the stages involved in processing an event queue received from a server computer on a client computer to handle the events contained in the queue.

FIG. 4 is a diagrammatic view of an execution context splitting system that uses server callbacks for one implementation.

FIG. 5 is a process flow diagram for one implementation illustrating the stages involved in generating execution context splitting code that utilizes server callbacks.

FIG. 6 is a diagrammatic view of a computer system of one implementation.

### DETAILED DESCRIPTION

The technologies and techniques herein may be described in the general context as techniques for facilitating server callbacks, but the technologies and techniques also serve other purposes in addition to these. In one implementation, one or more of the techniques described herein can be implemented as features within a software development program such as MICROSOFT® Visual Studio, or from any other type of program or service that creates, executes, and/or manages software programs.

As noted in the Background Section, the HTTP protocol has become the de facto standard for communication between the client web browser and the server that returns the web pages. The HTTP protocol only allows clients to initiate calls to the server, but does not provide a way for the server to initiate a call to the client. The inability for the server to call the client can create problems for various types of applications which need to be able to receive events from the server. For example, Asynchronous JavaScript and XML (AJAX) is a group of inter-related web development techniques used for creating interactive web applications. With AJAX, extra data is requested from the server and is loaded in the background without interfering with the display and behavior of the existing page.

Another example of where the inability of the server to call the client poses problems is with event-driven programming. With event-driven programming, a given program is driven by reacting to external events. In other words, an event-driven program first waits for events to actually occur and then responds to those events. The program then returns to waiting for the next event. The way the program responds to the given event depends on the event handling code that was written for that given event. Furthermore, the order in which an event-driven program executes depends on which events occur and on the order in which those events occur.

In programming platforms such as MICROSOFT®.NET, software developers can add events to their types by declaring an event delegate for callbacks that handle the event, and by defining a corresponding event member in the class. Events are then raised by invoking an event delegate. Interested programs can add event handler delegates to the event and will get notified when the event fires. Some exemplary source code is shown below, which will then be explained in the following section.

```
delegate void Handler(EventArguments a)
class C
{
  event Handler SomeEvent;
  // some method that raises the event
  void RaiseEvent( ){
    ...
    if(SomeEvent != null){
            EventArgs a = ...;
            SomeEvent(a);
          }
      ...
  }
}
```

The first line of code above starting with the word “delegate” is an example signature of what the request from the consumer who subscribes to the event should look like. In other words, if other parts of the program want to be notified when this event occurs, then the format of event delegate signature should be used by those consumers who registered for the event so that a notification can later be received when the event has occurred. The “class C” that is shown next in the example code above contains the code for the class that supports the event. In other words, class C contains code that gets executed when the event actually occurs to notify the subscribers to the event that the event in which they registered an interest has actually happened.

In order for the desired consumers of the event to “register an interest” in the event, they create a subscription to the event by registering an “event handler”. Each event handler that has been registered for a given event gets called when the class raises the event as described above. Here are a few examples for how event handlers can be registered.

C c = new C( ); // event source
...
c.SomeEvent += delegate(EventArguments a){ ...}; // one handler
...
c.SomeEvent += delegate(EventArguments a){ ...}; // another handler

Thus, through the event handling process, class C calls back to the client (instead of the client calling methods on class C). In other words, when the event is raised, each of the event handlers that were registered for the event are then called, and the code contained in each of those event handlers are executed.

An event handling model is problematic when portions of event-handling code are split across different computers for execution, due to the inability of a server to call back a client over HTTP. The control-flow is now inverted, instead of the client calling the server, the server now needs to call back to the client. Similarly, as noted earlier, the inability of a server to call back a client can pose problems for AJAX applications. Several workarounds are often used in event-driven programs and AJAX programs to get around this problem. For example, HTTP streaming is sometimes used where the server maintains an open HTTP connection and delivers partial results to the client. In such a scenario, the page never finishes loading. Callbacks from the server to the client can then be multiplexed over the open channel. Another approach sometimes used is to do a periodic refresh where the web browser on the client pings the server every so often to request changes, effectively implementing a push model via polling.

In one implementation, some techniques are described for implementing server callbacks. The term “server callback” as used herein is meant to include a call from a server computer back to a client computer to notify the client computer that a certain event or events have occurred for which the client computer requested that the server monitor. As noted above on the discussion on event programming, raising an event amounts to passing the event arguments to the event handlers that are added by the client as shown in the sequence of statements:

```
    ...
if(SomeEvent != null){
          EventArgs a = ...;
          SomeEvent(a);
          }
          ...
```

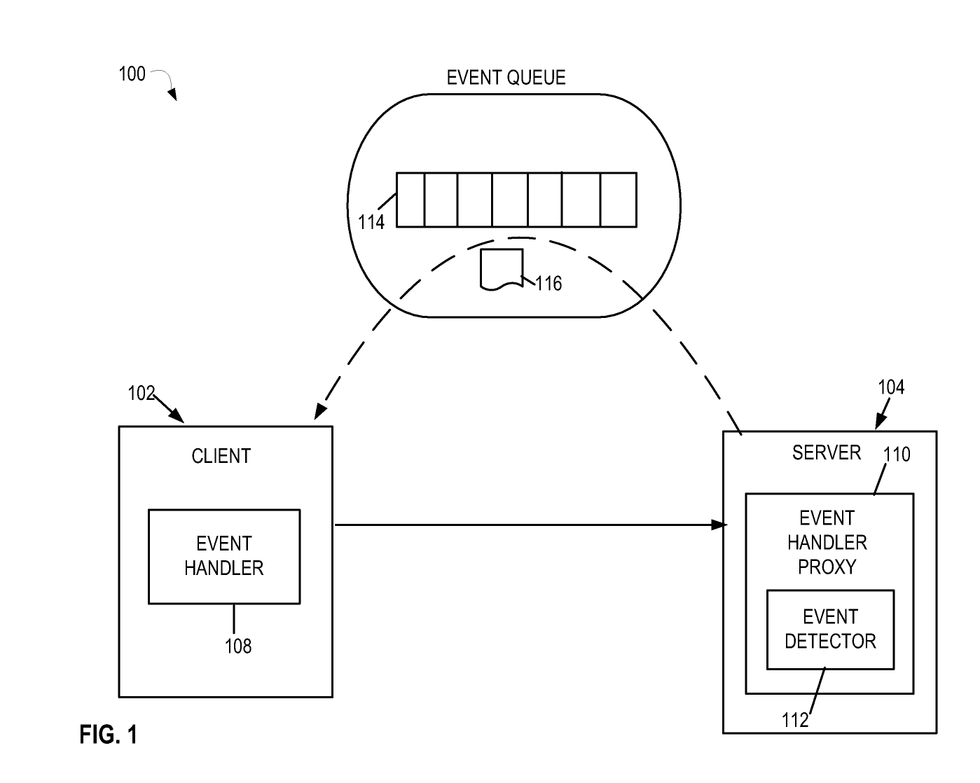

FIG. 1 shows a diagrammatic view of a server callback system 10 of one implementation where event handlers are run on a client computer (such as a web browser), but are raised on a server computer (such as a web server). The term “client computer” as used herein is meant to include a computer or device that is making a request to another computer to perform some operation. The “client computer” is a client with respect to that request being sent to the other computer, which in that scenario is the server computer. Thus, the term “server computer” as used herein is meant to include a computer or device that is receiving a request from a client computer to perform some operation. When an event happens, the event arguments are serialized to the client computer 102 and the event is signaled on the client computer. Event handlers 108 are registered at the client computer 102 and stay at the client computer 102. In other words, the server implementation of SomeEvent is an event handler proxy 110 that signals to the client side implementation of SomeEvent that an event has happened (i.e. was detected by event detector 112). In order for the server computer 104 to initiate a call to the client computer 102 to signal that the event has happened, the server implementation of SomeEvent(a) queues up the event argument 116 on the server computer in a server-side event queue 114. Then whenever the server computer 104 sends a response, any response, back to the client computer 102, the contents of the event queue 114 are piggybacked with the normal response back to the client computer (and emptied on the server computer 104). In some implementations, while a connection may be available with the client computer 102, server computer 104 may choose to wait and batch up events until a later time, such as to achieve greater processing efficiency. On the client, the event queue is deserialized and the events are re-raised on the client-side by event handler(s) 108. Depending on the client capabilities, this can be done before the normal result is delivered, or concurrently.

While just one client computer and one server computer are shown in FIG. 1 for the sake of simplicity, there can actually be more than one client computer 102 and/or more than one server computer 104 that utilize the techniques described herein. For example, there can be multiple client computers that register event handlers with a single server computer 104. In such a scenario, server computer 104 can maintain a separate queue for each client. Alternatively, server computer 104 can maintain a single queue that contains a client identifier that allows server computer 104 to extract only those entries related to a particular client computer 102 so that a filtered event queue 114 is sent to the client computer 102. As another non-limiting example, a single client computer 102 may register event handlers with more than one server computer 104. For example, one event handler proxy might be used on a web server, while another event handler proxy might be used on a database server. Numerous other combinations of client and server arrangements are also possible than those specifically mentioned herein. These techniques will now be described in further detail in the figures that follow.

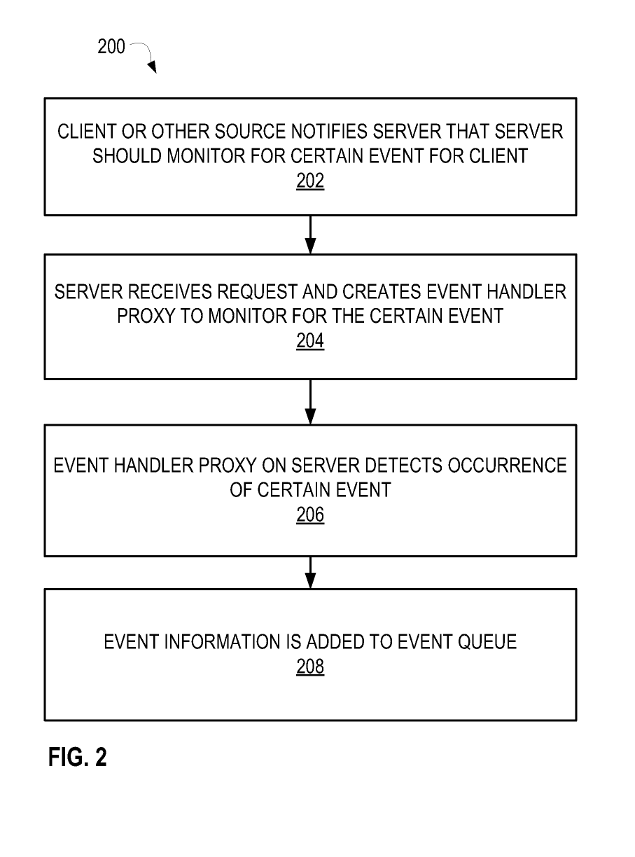

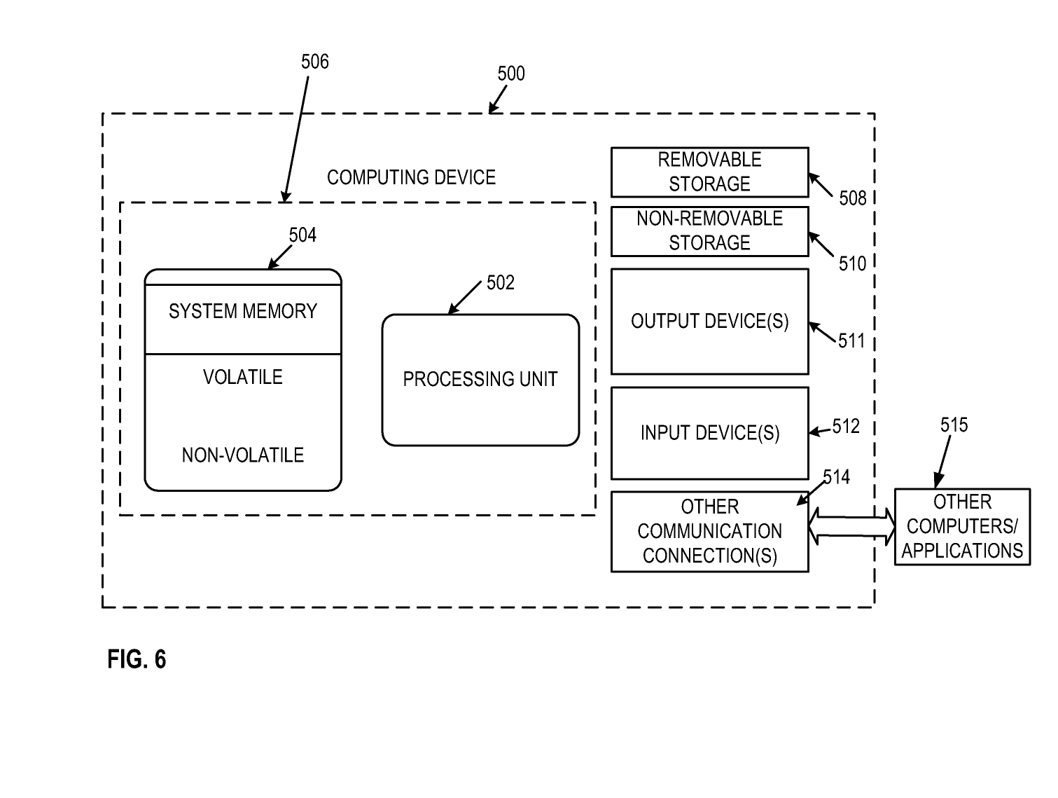

Turning now to FIGS. 2-5, the stages for implementing one or more implementations of server callback system 10 are described in further detail. In some implementations, the processes of FIG. 2-5 are at least partially implemented in the operating logic of computing device 500 (of FIG. 6).

FIG. 2 is a process flow diagram 200 for one implementation illustrating the stages involved in monitoring for events on a server computer and putting raised events into an event queue for handling on a client computer. An event handler on the client computer (or another source) notifies the server computer that the server should monitor for a certain event for the client computer (stage 202). In other words, a subscription request to an event is sent to the server computer. The server computer receives the request to subscribe to the certain event and creates an event handler proxy to monitor for the certain event (stage 204). The event handler proxy on the server detects the occurrence of the certain event (stage 206), assuming it actually happens. When the occurrence of the certain event is detected (stage 206), the event information is then added to an event queue (stage 208) so that it can be later send to the client computer for handling. In other words, the event queue is later serialized and sent to the client computer so the client computer can de-serialize the event queue and re-fire the events on the event handler on the client computer. In one implementation, the event information that gets added to the event queue includes the event delegate and any parameters needed by the event delegate. In another implementation, information that identifies the event delegate and any parameters needed by the event delegate are included instead of the actual event delegate statement itself. In such an implementation, the client computer will need to have knowledge that enables the client computer to invoke the correct event handler. The event queue itself can be located on the server computer, or it can simply be located on a separate computer from the server computer that is accessible by the server computer.

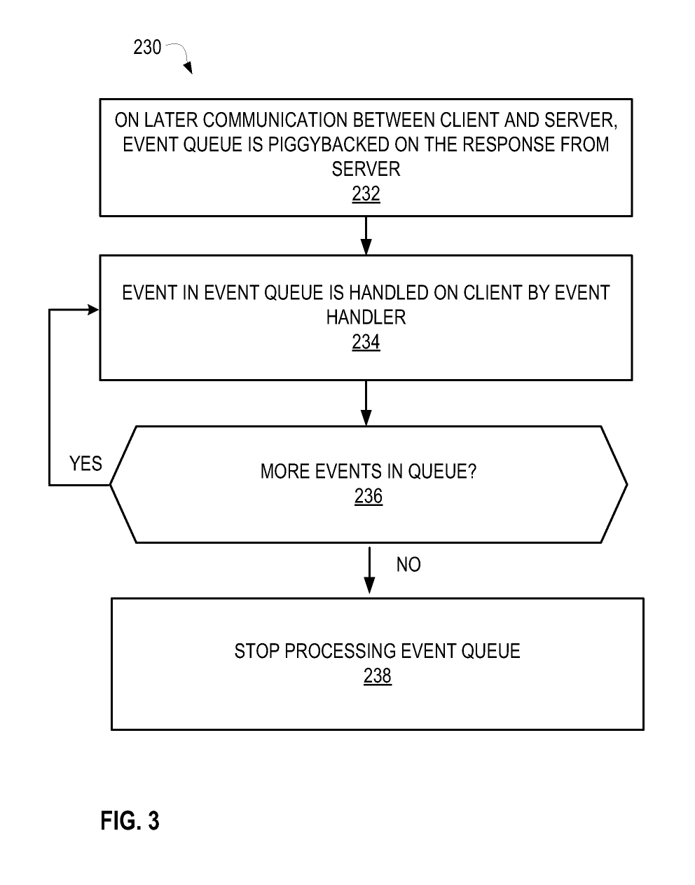

Turning now to FIG. 3, a process flow diagram 230 is shown for one implementation that illustrates the stages involved in processing an event queue received from a server computer. On a later communication between the client computer and the server computer, the event queue is piggybacked on the response from the server computer and sent to the client computer (stage 232). One non-limiting example of a later communication with the server computer can include the “next” communication that occurs between the client computer and the server computer. Another non-limiting example of a later communication with the server computer can include a special ping request sent from the client computer to the server computer to request the event queue. Yet another non-limiting example of a later communication with the server computer can include an already open connection with the server computer that is utilized.

After the event queue is received on the client, an event in the event queue is handled on the client by an event handler (stage 234). This can be the first event appearing in the event queue, or could also be some other order as would occur to one of ordinary skill in the art. In one implementation, where the queue has been populated with the actual event delegates and parameters, the actual event delegate is executed to invoke the event handler for the event retrieved from the event queue. In another implementation, where some other identifier for the event delegate is contained in the event queue instead of the event delegate itself, the actual event delegate and any needed parameters are retrieved or calculated, and are then executed to handle the event. The stages are repeated for each event in the event queue (stage 236), if more than one are present. When there are no more events to handle contained in the event queue, then the system stops processing the event queue (stage 238). Thus, the techniques described in FIGS. 2 and 3 enable events to be detected and raised on a server computer but handled on a client computer.

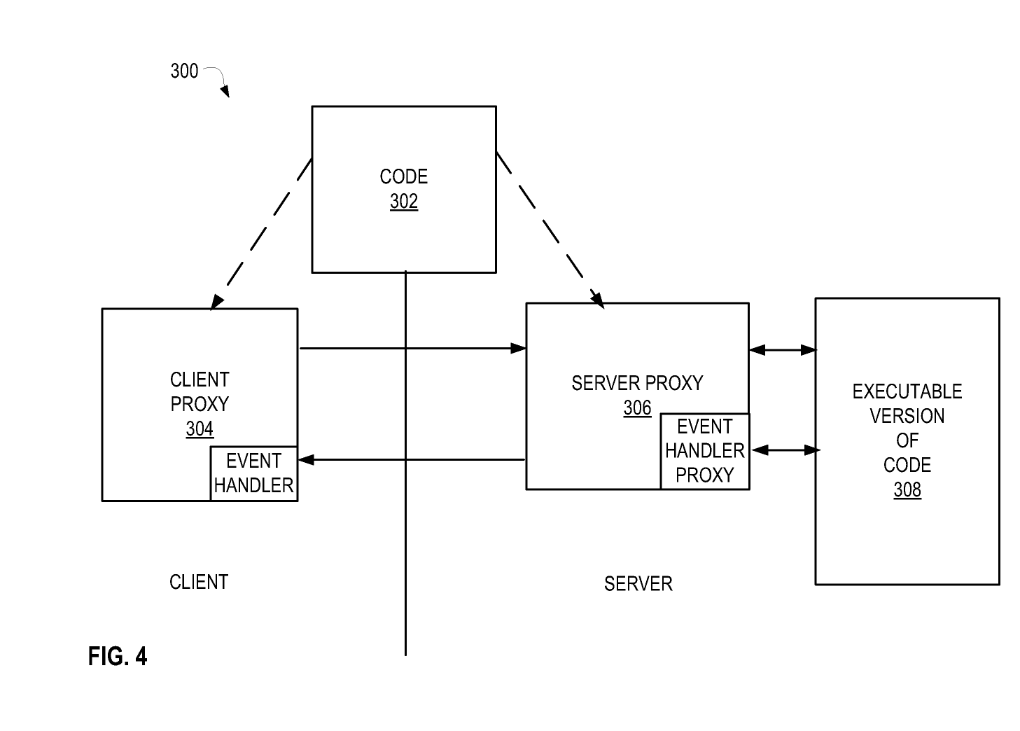

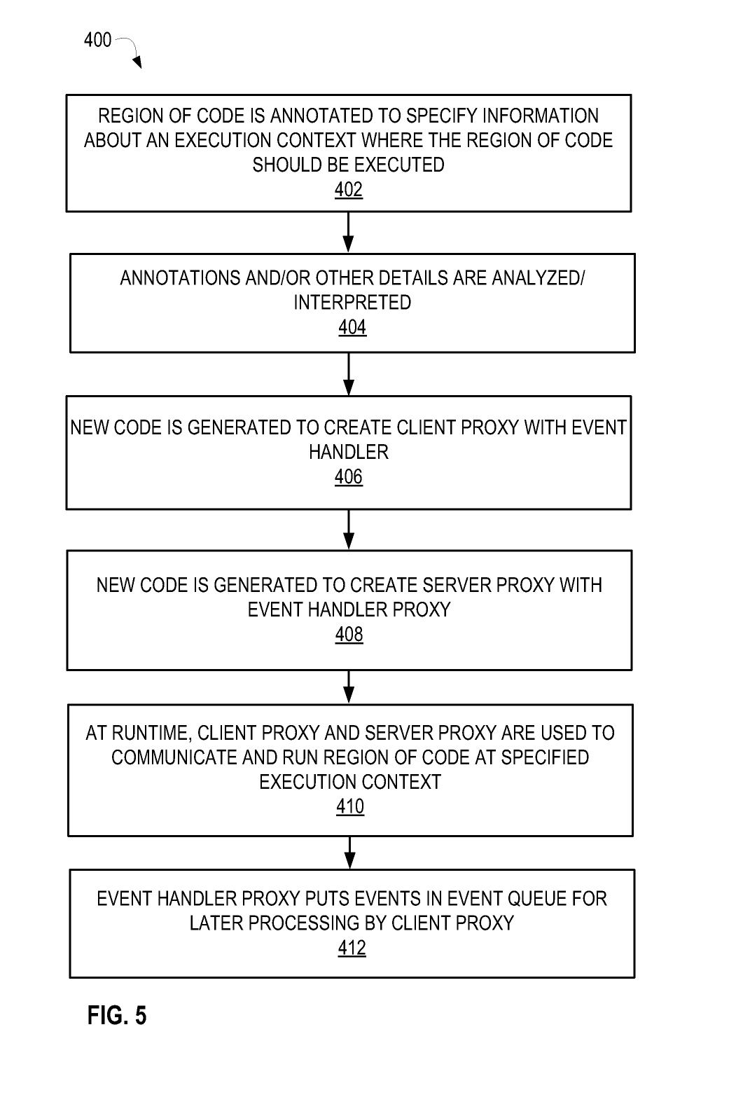

Turning now to FIGS. 4-5, some techniques will be described for using some of the server callback techniques described in FIGS. 1-4 with systems that split out execution of different parts of a region of code across different execution contexts (or tiers).

Starting with FIG. 4, a diagrammatic view of an exemplary execution context splitting system 300 is shown. The term “execution context” as used herein is meant to include a context or location upon which an executable version of code can be run. Examples of execution contexts include a different computer, processor, thread, core on a processor, and so on. In one implementation, execution context splitting system 300 is responsible for automatically implementing the server events as described above in case the class that gets moved from execution on the client to execution on the server has events defined in it. This will now be explained in further detail.

In one implementation, code 302 or some other data source (such as a configuration file) is marked with one or more annotations by a software developer or programmatically. The term “code” as used herein is meant to include source code, an intermediate language version of the source code, or any other representation of code for controlling a computer that can be transformed into machine or other instructions for execution on a computer. These annotations allow the software developer (or other user or program) to write code in a simpler fashion that is more like code that would normally just be for a single execution context (or tier), but that actually ends up being executed in multiple contexts. This is achieved by specifying different execution contexts on which different portions of the code should run. In other words, the software developer or automated program does not have to bother with writing the code to implement the execution of the program across the different execution contexts, as the system 300 generates the necessary infrastructure for allowing the proper communications to take place across these execution contexts.

An annotation associated with a particular region of code indicates that the region of code should be executed in a certain execution context (or more than one execution context). The term “region of code” as used herein is meant to include one or more contiguous or non-contiguous portions of code. A few non-limiting examples of a region of code can include a class, method, or other grouping of code. In one implementation, the annotation contains complete details about the execution context where the region of code should be executed. In another implementation, the annotation is just an indirect reference or other indicator to designate that the region of code should be executed elsewhere. Other variations are also possible.

The code 302 is analyzed to interpret the annotations and/or other details. A client proxy 304 with an event handler is created. The term “client proxy” as used herein is meant to include a program, service, or other executable logic that is responsible for receiving and forwarding a request to execute a region of code to a server proxy. Furthermore, a server proxy 306 with an event handler proxy is created. The term “server proxy” as used herein is meant to include a program, service, or other executable logic that is responsible for receiving a request to execute a region of code and for dispatching a call to an executable version of the region of code.

What this means is that client proxy 304 is responsible for receiving a request to call the region of code 302 (e.g. a particular method, etc.) and for opening or re-using a communication channel with the server proxy 306 to send an execution request to the server proxy 306. The server proxy 306 then receives the execution request and dispatches a call to an executable version of the code 302. The result of the execution of the code is then returned from the server proxy 306 to the client proxy 304.

A discussion will now follow on how event handler of client proxy 304 and the event handler proxy of server proxy 306 fit into the process. The event handler proxy of server proxy 306 is responsible for receiving a request from the event handler of client proxy 304 to monitor for certain events. Event handler proxy of server proxy 306 is responsible for monitoring for those events, and for putting the events into a queue if they occur.

On a later communication with the client proxy 304, the server proxy 306 sends the event queue so that the event handler of the client proxy 304 can process the events in the event queue using the techniques described previously in FIG. 3. The end result of this process is that a region of code is executed across multiple execution contexts, and a server callback is generated when an event is raised by the server proxy 306 (e.g. on the server) that then needs to be handled by an event handler of the client proxy 304 (e.g. on the client).

Turning now to FIG. 5, a process flow diagram 400 is illustrated for one implementation that describes the stages involved in generating declarative execution context splitting code that utilizes server callbacks. Some of the discussion of FIG. 5 is repetitive of what was previously discussed for FIG. 4, but is stated in a simplified way for the sake of clarity. A region of code is annotated to specify information about an execution context where the region of code should be executed (stage 402). The annotations and/or other details are analyzed and/or interpreted to determine the execution context(s) on which the region of code should be run (stage 404). New code is generated to create one a client proxy with one or more event handlers (stage 406). New code is also generated to create a server proxy with one or more event handler proxies (stage 408). At runtime, the client proxy and the server proxy are used to communicate and run the region of code at a specified execution context (stage 410). The event handler proxy of the server proxy puts events in the event queue for later processing by the event handler of the client proxy (stage 412).

As shown in FIG. 6, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 6 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 6 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A method for facilitating server callbacks comprising the steps of:
receiving a request from a client computer to monitor for one or more events for the client computer;
monitoring for the one or more events;
detecting one or more occurrences of the one or more events;
adding information regarding the one or more occurrences of the one or more events to an event queue; and
on a later communication with the client computer, sending the event queue as part of a response so the one or more occurrences of the one or more events can be handled on the client computer.

2. The method of claim 1, wherein the information added to the event queue includes one or more event delegates needed to handle the one or more events on the client.

3. The method of claim 2, wherein the information added to the event queue further includes one or more parameters needed to handle the one or more events on the client computer.

4. The method of claim 1, wherein the monitoring and detecting steps are handled by a server event handler proxy.

5. The method of claim 1, wherein the later communication with the client computer is a next communication with the client computer.

6. The method of claim 1, wherein the later communication with the client computer is a special ping requests that requests the event queue.

7. The method of claim 1, wherein the later communication with the client computer utilizes an already open connection with the client computer.

8. The method of claim 1, wherein the receiving, monitoring, detecting, adding, and sending steps enable the one or more events to be detected and raised on a server computer but handled on the client computer.

9. The method of claim 1, wherein the receiving, monitoring, detecting, adding, and sending steps are repeated for a plurality of client computers.

10. A method for handling events on a client that were raised on a server comprising the steps of:
receiving an event queue from a server computer on a later communication with the server computer, the event queue containing information regarding one or more events that were detected on the server computer; and
handling each of the one or more events in the event queue using one or more event handlers.

11. The method of claim 10, wherein the information regarding one or more events that is contained in the event queue includes one or more event delegates.

12. The method of claim 10, wherein the information regarding the one or more events that is contained in the event queue includes one or more parameters needed by the one or more event handlers to handle the one or more events.

13. The method of claim 10, wherein the later communication with the server computer is a next communication with the server computer.

14. The method of claim 10, wherein the later communication with the server computer is a special ping request sent to the server computer to request the event queue.

15. The method of claim 10, wherein the later communication with the server computer utilizes an already open connection with the server computer.

16. A computer-readable medium having computer-executable instructions for causing a computer to perform steps comprising:
generating a client proxy with an event handler, the event handler being operable to handle a certain event on a client computer; and
generating a server proxy with an event handler proxy, the event handler proxy being operable to detect one or more occurrences of the certain event on a server computer and put information regarding the one or more occurrences into an event queue for later handling by the event handler of the client proxy.

17. The computer-readable medium of claim 16, wherein the client proxy with the event handler is deployed to the client computer.

18. The computer-readable medium of claim 16, wherein the server proxy with the event handler proxy is deployed to the server computer.

19. The computer-readable medium of claim 16, wherein the client proxy and the server proxy are used to implement execution context splitting for a region of code.

20. The computer-readable medium of claim 16, further having computer-executable instructions for causing a computer to perform steps comprising:
prior to generating the client proxy, accessing one or more annotations associated with a region of code to determine an execution context regarding where the region of code should be executed; and
wherein the client proxy and the server proxy are generated to implement functionality needed to carry out the execution context for the region of code.
